(19) United States
(12) Patent Application Publication
(10) Pub. No.: US 2024/0198348 A1
(43) Pub. Date: Jun. 20, 2024

(54) TOOTH FORMATION AND TOOTH PICK FORMATION

(71) Applicant: MMD Group Limited, Laxey, Isle of Man (GB)

(72) Inventor: Christopher Pearson, Laxey, Isle of Man (GB)

(73) Assignee: MMD Group Limited, Laxey, Isle of Man (GB)

(21) Appl. No.: 18/288,141

(22) PCT Filed: May 18, 2022
(86) PCT No.: PCT/GB2022/051253

§ 371 Date: Oct. 24, 2023

(30) Foreign Application Priority Data
May 19, 2021 (GB) 2107129.5

(51) Int. Cl. B02C 13/28

(52) U.S. Cl. CPC B02C 13/2804; B02C 2013/2808

(57) ABSTRACT

A tooth formation for use in a mineral processing machine is described. The tooth formation has: a pick formation comprising an elongate body comprising a shaft having at one axial end a mineral breaking pick head extending radially beyond the elongate body to define a rearwardly facing first seating surface; and a support formation defining a receiving aperture of complementary shape and size to said shaft of said elongate body so as to receive the same, and a forwardly facing second seating surface configured to abut the first seating surface of the pick formation with the shaft so received. The first and second seating surfaces comprise arrangements of one or more complementary projections and recesses radially symmetrically disposed about an axial direction of the elongate body. A mineral processing machine including at least one and preferably a plurality of tooth assemblies or tooth cap assemblies according to any preceding claim. A drum assembly for a mineral processing machine having tooth assemblies thereon and a machine incorporating

### FIELD OF THE INVENTION

The present invention relates to a tooth formation, a tooth pick formation, and a tooth assembly for use in a mineral processing machine. The present invention relates for example to a tooth formation, a tooth pick formation, and a tooth assembly for use in a mineral sizer or breaker. The invention further concerns a mineral processing machine incorporating one or more such teeth and for example a mineral sizer or breaker drum that includes a plurality of such teeth assembled thereon in situ.

### BACKGROUND TO THE INVENTION

Mineral breaking teeth are widely used in mineral processing machinery which are used for breaking mineral. This may be for the purpose of winning mineral from mineral deposits or for the purpose of breaking down lumps of mineral after mining.

A typical tooth design includes a forwardly projecting pick formation. This pick formation takes a disproportionate amount of wear as it engages in use with the mineral to be worked.

This can create conflicting material requirements for different parts of the tooth. In order to be capable of breaking minerals, and particularly hard minerals, a strong and resilient tooth body is needed. However a harder and more wear resistant pick is desirable.

A known solution is to provide a detachable pick formation that is received and anchored in place in a support body. Advantageously, the pick formation in such a case can be made of different and more wear resistant material from that of the support body and/or may be made to be removable for replacement.

Such considerations apply for example in mineral sizers/mineral breakers. An example of such a sizer, having a pair of such counter-rotating breaker drums, is disclosed in the applicant's European patent No. EP0167178. The invention for example concerned with tooth assemblies and drum assemblies for use with mineral sizers or breakers of the general type disclosed in the applicant's European patent No. EP0167178.

In mineral sizers/mineral breakers, mineral lumps of various size, hardness and material type, for example from initial run-of-mine, are broken down into smaller pieces for onward processing. A sizer/breaker typically comprises a plurality of toothed rollers with arrays of projecting teeth adapted by shape and configuration of array to work on the mineral lumps and effect breaking, for example by gripping the lumps and creating tensile forces, compressive forces or a mixture of tensile and compressive forces to cause the lump to break in a snapping action and/or crushing action.

A typical tooth design for such a breaker or sizer projects outwardly from the roller on which it is carried to include a pick formation projecting forwardly in a roller rotation direction. This pick formation takes a disproportionate amount of wear as it engages in use with the mineral lumps to be worked and sized.

This can create conflicting material requirements for different parts of the tooth. In order to be capable of breaking minerals, and particularly hard minerals, it is necessary to be able to transmit, from a drive shaft, relatively large forces, and a strong and resilient tooth body is needed. However in order to deal with abrasive minerals over time, a highly wear resistant tooth surface is required. This requirement applies particularly to the pick.

Again, a known solution is to provide a detachable pick formation that is received and anchored in place in a support body. An example of a pick formation held in place in a support body and thereby enabled to be manufactured from harder and more wear resistant material is described in applicant's international patent publication No. WO03/006165 A1. Advantageously, the pick formation is fabricated of wear resistant material and made a consumable part that is removable for replacement.

Further optionally, the support formation may comprise part of a more complete tooth assembly made of multiple components, for example including a more wear resistant cover or covers to provide more wear resistant outward surface(s) to the tooth behind the pick. For example, it is known to provide sizers or breakers in which the tooth comprises a tooth cap assembly comprising plural components assembled in situ so as to sit upon a tooth core or horn carried on the rotating shaft. In this way, different parts of the tooth may be adapted to the different material requirements.

It is recognised in all cases that picks need to be firmly anchored in the support body so that in use the pick is rigidly held in the supporting body without movement. However, it is also recognised that picks should be readily replaceable in order to enable new picks to be fitted once old picks have worn to a degree that mandates replacement.

These two requirements have tended to be opposing in that a pick which is easy to replace, in use, tends to be more likely to work loose causing premature fracture of the pick, fall-out of the pick, and/or enlargement of the pick seat in the supporting body. Alternatively, a pick which is rigidly held in a supporting body without movement has tended to be difficult to remove after use.

A general aim of the present invention is to provide a tooth formation for a mineral processing machine such as a mineral sizer or breaker a including a mineral breaking tooth pick formation and a support formation in which the pick is capable of being rigidly held in a supporting body without movement and yet, after use, is easy to replace.

In particular, the present invention aims to provide a tooth cap assembly for a mineral processing machine such as a mineral sizer or breaker comprising such a mineral breaking tooth pick formation and a support formation.

More completely, the present invention aims to provide a mineral sizer or breaker drum that includes a plurality of teeth assembled thereon in situ, each including such a mineral breaking tooth pick formation and a support formation, each such support formation for example comprising or comprising a part of a tooth cap assembly seated upon a horn or core thereon.

### SUMMARY OF THE INVENTION

According to a first aspect of the present invention there is provided a tooth formation for use in a mineral processing machine, comprising:
a pick formation comprising an elongate body comprising a shaft having at one axial end a mineral breaking pick head extending radially beyond the elongate body to define a rearwardly facing first seating surface;
a support formation defining a receiving aperture of complementary shape and size to said shaft of said elongate body so as to receive the same, and a forwardly facing second seating surface configured to abut the first seating surface of the pick formation with the shaft so received;
wherein the first and second seating surfaces comprise arrangements of one or more complementary projections and recesses radially symmetrically disposed about an axial direction of the elongate body.

In an assembled state, the shaft of the pick formation is received axially into the receiving aperture of the support formation and held therein such that the first and second seating surfaces are caused to come into intimate abutting engagement. Particularly preferably, in the assembled state, the first and second seating surfaces are urged into said intimate abutting engagement by force generating means disposed to act between the pick formation and the support formation, and for example disposed to act on the shaft of the pick formation to draw the same into the receiving aperture of the support formation.

In this generally familiar manner there may provided a mineral breaking pick head that is fabricated from suitable hard wearing material and locatable into a tooth assembly in a manner that is capable of being held during use and yet, after use, is replaceable by removal of the pick formation from the support formation and its replacement with a new pick formation.

The invention is distinctly characterised by provision, on the respectively abutting first and second seating surfaces, of arrangements of complementary projections and recesses radially symmetrically disposed about an axial direction of the elongate body.

These complementary projections and recesses serve both to facilitate the location of the pick formation into assembled engagement with the support formation in such a manner that the respective axes of the shaft and the receiving aperture are accurately aligned, and to tend to hold the same in stable alignment in use, resisting any sideways movement in situ in use such as might generate bending forces on the shaft and/or tend to cause wear on the receiving aperture in the support formation where the shaft seats.

By this means, the pick formation is capable of being rigidly held in a support formation with minimal movement during use, and in particular without excessive movement of the shaft in the receiving aperture that might cause excessive wear on the shaft and premature failure of the pick formation and/or enlargement of the receiving aperture which might otherwise render the support formation unable to seat a subsequent replacement pick formation properly. However, replacement of a worn pick formation with a new pick formation remains easily effected.

As the seating of the pick formation in situ is at least partly effected by the engagement of the first and second seating surfaces, a shorter shaft may be employed than in some prior art systems. A simple cylindrical shaft geometry may be employed in contrast to some prior art systems. Thus, in preferred embodiments, the pick formation may comprise a shaft having a cylindrical shape and the support formation may comprise a complementarily shaped and sized cylindrical receiving aperture.

To avoid the generation of lateral forces, the first and second seating surfaces comprise arrangements of complementary projections and recesses that are radially symmetrically disposed about an axial direction of the elongate body.

Most simply, the complementary projections and recesses may be annularly disposed about the axial direction to comprise a single annular arrangement, for example comprising respectively a complete annular projection or plural arcs thereof on one of the said seating surfaces and a complete annular recess or plural arcs thereof on the other of the said seating surfaces. However, the invention encompasses any other suitable arrangement of complementary projections and recesses that are radially symmetrically disposed.

Projections may be provided in the first seating surface and complementary recesses in the second seating surface. Projections may be provided in the second seating surface and complementary recesses in the first seating surface. Each of the first seating surface and the second seating surface may be provided with both projections and recesses.

The projections and recesses may have any suitable complementary shape. In some embodiments, the one or more recesses may comprise curved grooves, and for example grooves having an arcuate profile in transverse section and for example grooves having a profile of a circular arc, with the one or more projections having correspondingly curved, and for example arcuate and for example circular profile. In some embodiments, the recesses may comprise v-shaped grooves, with the projections having correspondingly v-shaped profile. In some embodiments, the recesses may comprise ogival grooves, with the projections having correspondingly ogival curved profile. Other shapes of complementary grooves and projections may be suitable for particular embodiments of the invention.

In a particular preferred case, one of the said first and second seating surfaces comprises a single complete annular arcuate groove and for example semi-circular groove and the other of said seating surfaces comprises a single complete annular arcuate and for example semi-circular projection.

The pick formation comprises a shaft having at one axial end a mineral breaking pick head. A rearmost portion of the pick head extends radially beyond the shaft of the elongate body to define a rearwardly facing first seating surface and the pick head extends forwardly therefrom towards a tip.

The pick head thereby defined may be of any suitable shape and in particular of any suitable known shape.

In some embodiments, the pick head comprises a tapered portion that tapers in a direction forward of the first seating surface, towards the tip. The pick head may comprise a non-tapered base portion extending immediately forward of the first seating surface and a tapered body portion extending towards a planar or convex or pointed tip.

In some embodiments, the pick head comprises a solid of revolution centred on the longitudinal axis of the pick formation.

The tapered portion may have a linear profile, for example forming a conic surface or part thereof, or a curved profile, for example forming a domed surface or part thereof.

For example, the pick head may comprise a spheroidal or frusto-spheroidal or conical or frusto-conical or ogival structure. For example alternatively the pick head may comprise an spheroidal of frusto-spheroidal or conical or frusto-conical or ogival tip with a cylindrical base portion.

The shaft of pick formation extends axially behind the mineral breaking pick head and is preferably former integrally therewith, for example welded thereto or formed as a one-piece casting or forging, optionally further machined into the desired shape.

The shaft of the pick formation is received axially into the receiving aperture of the support formation and held therein such that the first and second seating surfaces are caused to come into intimate abutting engagement.

Particularly preferably, in the assembled state, the first and second seating surfaces are urged into said intimate abutting engagement by force generating means disposed to act between the pick formation and the support formation and operable to generate a force to urge the first and second seating surfaces into said intimate abutting engagement, and for example disposed to act on the shaft of the pick formation, and operable to draw the same into the receiving aperture of the support formation.

In some embodiments, the pick formation comprises such force generating means. For example, the pick formation comprises at one axial end of the shaft a mineral breaking pick head and at the other, opposite axial end, force generating means.

The force generating means are for example tensile force generating means disposed to act on the shaft and be operable to draw the shaft into the receiving aperture of the support formation and thereby produce an urging force urging the first and second seating surfaces into intimate abutting engagement.

In some embodiments, the pick formation comprises at one axial end of the shaft a mineral breaking pick head and at the other, opposite axial end, tensile force generating means.

Preferably, the tensile force generating means comprise a threaded connection system operable to cause the shaft to be drawn in tension into a configuration that brings the first seating surface into intimate engagement with the second seating surface.

In a possible example, the threaded connection system comprises an internally threaded portion of the shaft at the said opposite axial end and a threaded bolt engageable therein so as to be operable to cause the shaft to be drawn in such manner as to bring the first seating surface into intimate engagement with the second seating surface.

In a possible example of such an arrangement, the support formation comprises an elongate aperture defining at a first axial end the said a receiving aperture of a first diameter of complementary shape and size to said shaft of said elongate body so as to receive the same, and defining extending beyond the said receiving aperture to a second, opposite axial end, a bolt housing aperture of second, lesser diameter to the receiving aperture to receive a shank of said bolt.

In this way, to act as the required tensile force generating means, the bolt shank is passed through the bolt housing aperture with a threaded end thereof extending into the internally threaded portion of the shaft. The bolt head is sized larger than the diameter of the bolt housing aperture. Tightening the bolt draws the shaft into the receiving aperture in such manner as to generate a tensile force that urges the first seating surface into intimate engagement with the second seating surface. Loosening of the bolt facilitates removal of the pick for replacement after a period of use.

The foregoing tooth formation comprising a mineral breaking tooth pick formation and a support formation as above described may find particular use comprising or comprising part of a tooth cap assembly for a mineral sizer or breaker.

In an example embodiment of the same, the present invention comprises a tooth cap assembly for a mineral processing machine such as mineral sizer or breaker comprising a mineral breaking tooth pick formation and a support formation as herein described, the support formation comprising at least a part of a tooth cap, the tooth cap being adapted to be detachably or fixedly mounted on a mineral processing machine, and for example on a radially projecting mounting boss or horn of a mineral sizer or breaker drum.

As will be familiar to those skilled in the art, a common arrangement for a projecting breaker tooth which might be carried on a rotating shaft of a mineral breaker or sizer is to provide a mounting projection in the form of a horn or boss radially projecting from the shaft and a tooth cap which is mounted upon the horn or boss and provides the primary breaking structure of the tooth.

The tooth cap may be a modular structure, and other additional components or modules may be present to complete the tooth structure in the assembled condition. Such an arrangement, as will be familiar, allows material selection for the different requirements of the different components, and in particular the toughness that is required of the horn or boss to transmit the substantial braking forces from the shaft to the active surface of the tooth, and the hardness required of the components making up the active service of the tooth, and in particular of the pick.

In accordance with the example embodiment of the invention, the tooth formation of the first aspect of the invention is conformed as at least a part of such a tooth cap, in that the support formation is adapted to be detachably or fixedly mounted onto such a radially projecting mounting boss or horn of a mineral sizer or breaker drum. The support formation may be adapted to be directly mounted onto the radially projecting mounting boss or horn of a mineral sizer or breaker drum or indirectly mounted via one or more intermediate structures. For example, the support formation may be shaped to receivingly seat over the radially projecting mounting boss or horn either directly or indirectly as the case may be.

Tooth caps comprising a support body and a detachable pick formation will be familiar to those skilled in the art, and the principles of the invention are generally applicable to such known tooth cap designs. In particular for example, the skilled person will appreciate that a more complete tooth cap assembly may comprise a support formation and a pick formation of the first aspect of the invention together with additional modules to complete a tooth assembly when the same is assembled in situ on a horn or boss. For example, one or more further cover formations may be provided to complete the outer surface of the tooth. One or more intermediate formations may line between those components making up the outer surface of the tooth and the horn or boss. Such modular designs will be familiar.

In this way, the various components, and in particular the various components making up the outermost surface of the assembled tooth and subject to the most severe wear, may be made of a more wear resistant material and/or may be made removable for replacement.

According to a second aspect of the present invention there is provided a mineral processing machine, preferably a mineral sizer or breaker, including at least one and preferably a plurality of tooth assemblies or tooth cap assemblies according to the first aspect.

According to a third aspect of the invention there is provided a drum assembly for a mineral sizer or breaker, the drum assembly including a plurality of toothed annuli mounted on a drive shaft, each annulus having a plurality of tooth assemblies or tooth cap assemblies according to the first aspect spaced about its circumference detachably or fixedly mounted on a radially projecting mounting boss or horn.

According to a fourth aspect of the invention there is provided a mineral sizer or breaker including a drum assembly according to the third aspect.

According to a fifth aspect of the invention there is provided a tooth pick formation as herein described for use with a support formation as herein described, in particular as a replacement part in a tooth formation as herein described.

### BRIEF DESCRIPTION OF THE DRAWINGS

The invention will now be described by way of example only with reference to the accompanying drawings in which:

FIG. 1 is A cross-section view of a tooth formation according to an embodiment of the first aspect of the invention conformed as part of a tooth cap assembly for a mineral sizer or breaker, positioned in situ on a mounting horn of a mineral sizer or breaker drum;

FIG. 2 is a plan view of a mineral sizer or breaker including two breaker drum assemblies, the drum assemblies including a plurality of toothed annuli comprising formations such as in FIG. 1 mounted to be driven on respective drive shafts.

### DETAILED DESCRIPTION OF PREFERRED EMBODIMENTS

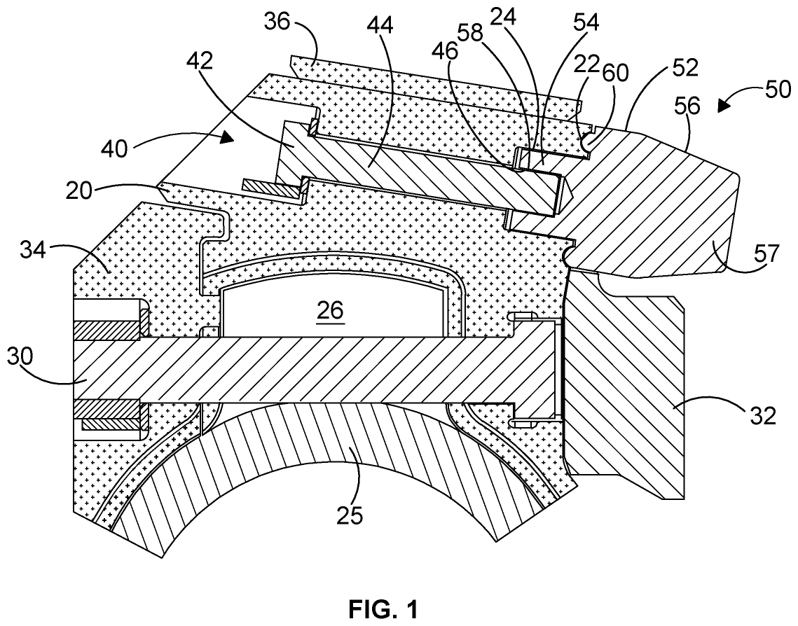

Referring to FIG. 1, an example embodiment is shown in cross-section of a tooth formation in accordance with the first aspect of the invention comprising a pick formation and a support formation as hereinabove discussed. The tooth formation is shown in the assembled state, and is conformed as a tooth cap and shown positioned on a projecting horn of a rotatable shaft of a mineral breaker or sizer to form part of a tooth assembly thereon.

The support formation (20) of FIG. 1 thus constitutes a tooth cap mounted on the horn (26) which forms a radially projecting boss projecting outwardly from a rotatable drum (25) of a breaker or sizer. The support formation (20) is shaped to seat over and partly around the horn (26) together with which when in situ it forms the main part of a tooth body. The support formation (20) defines a supporting body for a mineral breaking pick (50), with the two components in combination defining a tooth formation and serving as a tooth cap assembly in accordance with the present invention.

The pick (50) comprises an elongate body formed of a suitable metal such as a heat hardenable steel such as grade EN24 steel, and is preferably formed as an integral whole, for example as a single casting or forging, and then machined to accurate shape and dimensions.

The elongate body has at one axial end a pick head comprising a frustoconical tapered portion (56) and a cylindrical base portion (52).

The frustoconical portion (56) has a taper angle so that the pick head tapers from a wider diameter at the base portion (52) to a lesser diameter at the frustoconical surface (57). In the present example, the taper angle is about 15°, but it will be appreciated that the taper angle may be greater or less than 15° as appropriate to the design requirements of the breaker or sizer.

The shape of the pick head is only presented by way of example, and other known or otherwise suitable shapes may be considered as appropriate to the requirements of the sizeable breaker with which the invention is to be used. The invention rather lies primarily in the manner in which the pick head is secured into the support body.

The elongate body of the pick (50) extends rearwardly of the cylindrical portion (52) to comprise a shaft (54) which includes an internally screw threaded recess (58). This internally threaded portion threadingly engages with a correspondingly threaded portion (46) of a bolt (40). The shank (44) of the bolt is received in a suitable cavity in the support formation (20), such that an action on the bolt head (42) is capable of drawing the pick head into engagement on the support formation (20). Thus, the internally threaded portion of the pick cooperates with the bolt to constitute tensile force generating means operable to tend to draw the shaft into the complementary receiving recess in the support formation (20).

The distinctively characterising feature of the invention is the provision, on respectively abutting first and second seating surfaces of the pick and the support formation, of arrangements of complementary projections and recesses.

In the specific illustrated example, an annular arcuate projection (60) formed on a reward otherwise planar face of the base portion (52) of the pick head is cooperably sized and shaped with a corresponding arcuate groove (22) formed on a forward otherwise planar face of the support formation (20). Appropriate tightening action on the bolt causes it to act as a tensile force generating means to draw the shaft of the pick and urges the arcuate projection to be drawn into intimate seating in the groove. Correspondingly, appropriate loosening action on the bolt facilitates removal of the pick for replacement.

This arrangement confers two advantages. It facilitates alignment during assembly and it facilitates rigid engagement when assembled, in particular limiting axial movement of the shaft (54) which might otherwise cause unacceptable wear in the recess (24) within the support formation (20), causing damage to the same and so making it more difficult to effect a useful replacement of the pick (50) when it has reached the end of its useful life.

In the embodiment a simple single annular structure is shown with a projection on the rear surface of the pick head and a recess in the forward surface of the support formation. Equally, an alternative might be presented in which a projection was provided on the forward face of the support formation to engage a complimentary recess on the rearward face of the pick head. Moreover, although a simple single continuous annular projection and recess arrangement is shown by way of example, the invention encompasses other arrangements. Generally, any arrangements which disposes loads evenly in a radially symmetrical manner about a longitudinal axis of the pick head is likely to confer the advantages of the invention.

The support formation (20) is fixed to the horn (26) using the further bolt (30), and thus serves as a tooth cap in conventional manner.

The illustrated complete tooth assembly of FIG. 1 includes other components to complete a tooth structure, comprising the forward and rearward cover formations (32), (34) and a top cover (36). These are by way of example only. Various suitable modular tooth assemblies, comprising a tooth cap modified by provision of a connection in accordance with the principles of the invention, suitable for attachment to a horn or boss, and in conjunction with various other tooth modules, and in particular cover modules to constitute a part of the outer surface of the assembled tooth, will readily suggest themselves to the person skilled in the art.

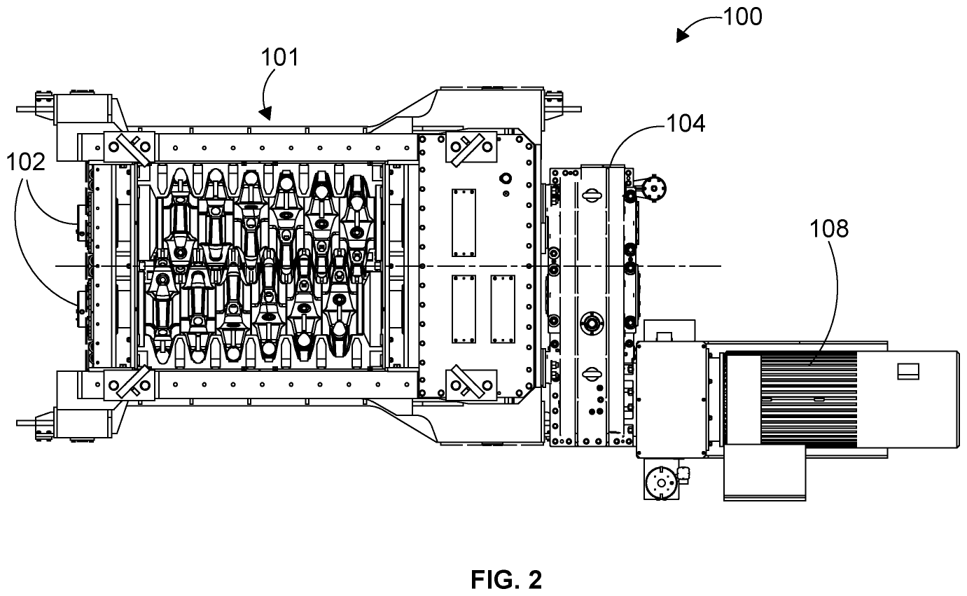

Plural tooth formations such as above described may be mounted on a breaker drum assembly of a mineral sizer or breaker, such as will be familiar. Referring to FIG. 2, a plan view is shown of an example mineral sizer including two breaker drum assemblies, the drum assemblies including a plurality of toothed annuli comprising formations such as illustrated in FIG. 1 mounted to be driven on respective drive shafts.

The sizer (100) includes a housing (101) having sides and end walls. The housing is conveniently fabricated from steel plate panels which are bolted and welded together.

Rotatably mounted to extend between the end walls are a pair of breaker drum assemblies on respective shafts (102). The shafts are each geared at one end via a gearbox (104) so that they are driven from a common drive (108) to be rotated, for example in opposite directions so as to direct material between them. The gear connection between the drums also serves to set the rotary positions of the drums relative to one another.

Each drum assembly is provided with circumferentially extending groups of breaker teeth, the groups being spaced axially along the drum assembly in a manner which will be familiar. The axial spacing of groups on one drum assembly is staggered to that on the other drum assembly so the teeth in a group on one drum assembly pass between an adjacent pair of groups on the other drum assembly in the manner shown in FIG. 2.

In embodiments of the invention, each tooth comprises a tooth formation such as illustrated in FIG. 1 mounted on a horn (26 in FIG. 1) which forms a radially projecting boss or horn projecting outwardly from the rotatable drum (25 in FIG. 1). Circumferentially extending axially spaced groups of these bosses or horns locate the teeth to be spaced in the manner described.

A tooth formation of the invention may find application across the range of prior art sizers and breakers in which circumferentially extending axially spaced bosses or horns provide a mounting for a tooth assembly in the described manner.

The shape of teeth and their relative positions and size are such that during use, two types of breaking action are present, a primary breaking action on larger pieces of mineral whereat the mineral is gripped between opposing leading faces of teeth on opposite drums and a secondary breaking action wherein mineral is trapped between the rear edges of teeth and the leading face of another tooth. The shape of the teeth may be designed bearing in mind the hardness and tensile strength of the mineral to be broken, for example to provide optimally for these actions. The modular construction allows for material selection for different components, for example for the pick, to be optimized with such functionality in mind, while the connection provided in accordance with the invention facilitates replacement of different components, in particular the pick.

1.-22. (canceled)

23. A tooth formation for use in a mineral processing machine, comprising:
a pick formation comprising an elongate body comprising a shaft having first and second axial ends, wherein one of the first and second axial ends comprises a mineral breaking pick head extending radially beyond the elongate body to define a rearwardly facing first seating surface; and
a support formation defining a receiving aperture having a shape and size complementary to the shaft and capable of receiving the shaft, and a forwardly facing second seating surface configured to abut the first seating surface of the pick formation in an assembled state,
wherein the first and second seating surfaces comprise arrangements of one or more complementary projections and recesses radially symmetrically disposed about an axial direction of the elongate body.

24. The tooth formation of claim 23, wherein the complementary projections and recesses are annularly disposed about the axial direction.

25. The tooth formation of claim 24, wherein the complementary projections and recesses are annularly disposed to comprise a single annular arrangement.

26. The tooth formation of claim 25, wherein the complementary projections and recesses respectively comprise a complete annular projection on one of the first and second seating surfaces and a complementary annular recess on the other of the seating surfaces.

27. The tooth formation of claim 25, wherein the complementary projections and recesses respectively comprise plural arcs each comprising a part of an annular projection on one of the first and second seating surfaces and complementary arcuate recess on the other of the seating surfaces.

28. The tooth formation of claim 23, wherein the complementary projections and recesses respectively comprise one or more grooves having an arcuate profile in transverse section and one or more complementary projections having an arcuate profile.

29. The tooth formation of claim 23, wherein the complementary projections and recesses respectively comprise one or more grooves having a V-shaped profile in transverse section and one or more complementary V-shaped projections.

30. The tooth formation of claim 23, wherein the shaft has a cylindrical shape, and wherein the support formation comprises a complementarily shaped and sized cylindrical receiving aperture.

31. The tooth formation of claim 23, wherein the mineral breaking pick head comprises a rearmost portion that extends radially beyond the shaft of the elongate body to define the rearwardly facing first seating surface and the pick head extends forwardly therefrom towards a tip.

32. The tooth formation of claim 31, wherein the pick head comprises a tapered portion that tapers in a direction forward of the first seating surface and towards the tip.

33. The tooth formation of claim 32, wherein the pick head comprises a non-tapered base portion extending immediately forward of the first seating surface and a tapered body portion extending towards a planar or convex or pointed tip.

34. The tooth formation of claim 23, further comprising a force generating means operable to force the first and second seating surfaces to abut in an assembled state.

35. The tooth formation of claim 34, wherein the force generating means is located at the other of the first and second axial ends opposite the mineral breaking pick head.

36. The tooth formation of claim 34, wherein the force generating means comprises tensile force generating means disposed to act on the shaft and be operable to draw the shaft into the receiving aperture.

37. The tooth formation of claim 36, wherein the tensile force generating means comprises a threaded connection system operable to cause the shaft to be drawn in tension into a configuration that brings the first seating surface into intimate engagement with the second seating surface.

38. The tooth formation of claim 37, wherein the threaded connection system comprises an internally threaded portion of the shaft and a threaded bolt engageable therein.

39. A tooth cap assembly comprising the tooth formation of claim 23, wherein the support formation comprises at least a part of a tooth cap, and wherein the tooth cap is detachably or fixedly mounted on a radially projecting mounting boss or horn of a mineral sizer or breaker drum.

40. A mineral processing machine including at least one tooth formation, wherein the tooth formation comprises:
a pick formation comprising an elongate body comprising a shaft having first and second axial ends, wherein one of the first and second axial ends comprises a mineral breaking pick head extending radially beyond the elongate body to define a rearwardly facing first seating surface; and
a support formation defining a receiving aperture having a shape and size complementary to the shaft and capable of receiving the shaft, and a forwardly facing second seating surface configured to abut the first seating surface of the pick formation in an assembled state,
wherein the first and second seating surfaces comprise arrangements of one or more complementary projections and recesses radially symmetrically disposed about an axial direction of the elongate body.

41. A drum assembly for a mineral sizer or breaker, wherein the drum assembly comprises a plurality of toothed annuli mounted on a drive shaft, and wherein each annulus comprises a plurality of tooth formations, where each tooth formation comprises:
a pick formation comprising an elongate body comprising a shaft having first and second axial ends, wherein one of the first and second axial ends comprises a mineral breaking pick head extending radially beyond the elongate body to define a rearwardly facing first seating surface; and
a support formation defining a receiving aperture having a shape and size complementary to the shaft and capable of receiving the shaft, and a forwardly facing second seating surface configured to abut the first seating surface of the pick formation in an assembled state,
wherein the first and second seating surfaces comprise arrangements of one or more complementary projections and recesses radially symmetrically disposed about an axial direction of the elongate body.

42. A mineral sizer or breaker including the drum assembly of claim 41.
